(19) United States
(12) Patent Application Publication
(10) Pub. No.: US 2024/0399666 A1
(43) Pub. Date: Dec. 5, 2024

(54) PRINTED STRUCTURES HAVING UNIQUE IDENTIFIERS

(71) Applicant: International Business Machines Corporation, Armonk, NY (US)

(72) Inventors: Jeremy R. Fox, Georgetown, TX (US); Martin G. Keen, Cary, NC (US); Alexander Reznicek, Troy, NY (US); Bahman Hekmatshoartabari, White Plains, NY (US)

(21) Appl. No.: 18/326,290

(22) Filed: May 31, 2023

(51) Int. Cl. B29C 64/393; B33Y 30/00; B33Y 50/02

(52) U.S. Cl. CPC B29C 64/393; B33Y 30/00; B33Y 50/02

(57) ABSTRACT

Embodiments of the invention are directed to a computer system having a memory coupled to a processor system, wherein the processor system is operable to perform processor system operations that include accessing a model of a physical object; and accessing instructions associated with the model of the physical object. The instructions are used to control a printhead coupled to a unique-identifier-element-infused (UIE-infused) filament source to print the physical object from UIE-infused filament.

### BACKGROUND

The present invention relates in general to computer-controlled manufacturing equipment. More specifically, the present invention relates to computing systems, computer-implemented methods, and computer program products operable to control printing operations that form structures embedded or infused with unique-identifier elements (UIE) such as, for example, miniaturized physical unclonable function (PUF) elements.

Three-dimensional (3D) printing technology, also known as additive manufacturing, refers to a machine that fabricates a 3D physical object by using a printhead to successively form or deposit layers of material that will form a 3D physical object. The printhead operations are controlled by a computer that contains a 3D electronic model of the physical object. The 3D electronic model logically slices the physical object into several layers and provides instructions to the printhead for printing each layer. The instructions control the machine, and more specifically the printhead of the machine, to form/deposit each layer successively until the physical object is completed. The physical objects fabricated through 3D printing processes have a variety of shapes and geometries.

Product authentication systems are used to verify whether or not a product is genuine or fraudulent. Overall, the goal of these systems is to make it much harder, if not entirely impossible, for counterfeiters to copy and sell a product without permission.

### SUMMARY

Embodiments of the invention are directed to a computer system having a memory coupled to a processor system, wherein the processor system is operable to perform processor system operations that include accessing a model of a physical object; and accessing instructions associated with the model of the physical object. The instructions are used to control a printhead coupled to a unique-identifier-element-infused (UIE-infused) filament source to print the physical object from UIE-infused filament.

Embodiments of the invention are also directed to computer-implemented methods and computer program products having substantially the same features as the computer system described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts details of an exemplary computing environment operable to implement embodiments of the invention;

FIG. 2 depicts a simplified block diagram illustrating a system in accordance with embodiments of the invention;

FIG. 3 depicts a flow diagram illustrating a computer-implemented or computer-controlled method in accordance with embodiments of the invention;

FIG. 4 depicts a flow diagram illustrating a computer-implemented or computer-controlled method in accordance with embodiments of the invention;

FIG. 5 depicts a simplified block diagram illustrating a configuration of electrodes pairs, with each electrode pair having a random resistance value;

FIG. 6 depicts one of the electrode pairs depicted in FIG. 5 incorporated within a circuit in accordance with embodiments of the invention;

FIGS. 7A-7B depict a semiconductor structure after fabrication operations for forming a unique identifier element (UIE) in accordance with embodiments of the invention, in which:

FIG. 7A depicts the semiconductor structure after initial fabrication operations in accordance with aspects of the invention;

FIG. 7B depicts the semiconductor structure after initial fabrication operations in accordance with aspects of the invention; and

FIG. 7C depicts the semiconductor structure after initial fabrication operations in accordance with aspects of the invention;

FIG. 8 depicts a combined system diagram and flow diagram illustrating a printing device and a computer-controlled method in accordance with embodiments of the invention;

FIG. 9 depicts a simplified circuit diagram illustrating a UIE, along with a simplified signal diagram illustrating input/output signals associated with the UIE, both in accordance with embodiments of the invention; and

FIG. 10 depicts a simplified block diagram illustrating additional details of how a portion of the system shown in FIG. 1 can be implemented in accordance with embodiments of the invention.

In the accompanying figures and following detailed description of the disclosed embodiments, the various elements illustrated in the figures are provided with three-digit reference numbers. In some instances, the leftmost digits of each reference number correspond to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Similarly, conventional techniques related to semiconductor device and integrated circuit (IC) fabrication may or may not be described in detail herein. Moreover, the various tasks and process steps described herein can be incorporated into a more comprehensive procedure or process having additional steps or functionality not described in detail herein. In particular, various steps in the manufacture of semiconductor devices and semiconductor-based ICs are well known and so, in the interest of brevity, many conventional steps will only be mentioned briefly herein or will be omitted entirely without providing the well-known process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

Turning now to an overview of aspects of the invention, embodiments of the invention provide computing systems, computer-implemented methods, and computer program products operable to operable to control printing operations that print or form structures embedded or infused with one or more unique-identifier elements (UIEs), with each UIE incorporated within its own UIE circuit. In some embodiments of the invention, the UIE can be an element fabricated such that a selected UIE characteristic is unique for each fabricated instance of the UIE. For example, the UIE can include a “random component” (e.g., the size, shape, location, and/or fabrication technique of an insulator) that is different for each fabricated instance of the UIE and is provided at a level that is sufficient to substantially cause the unique UIE characteristic (e.g., a resistance of the UIE). The UIE can be incorporated in its own UIE circuit, which is operable to receive a stimulus signal and generate a unique/random response to the stimulus signal. The UIE can be located within its UIE circuit such that the unique UIE characteristic is at a sufficient level to cause the UIE circuit's response to be unique, random and detectable. In embodiments of the invention, the stimulus signal and the unique/random response are transmitted and received wirelessly. In some embodiments of the invention, a plurality of UIEs are embedded in the printed structure; each of the plurality of UIEs is included in its own UIE circuit; and each response generated by the plurality of UIE circuits is unique and random. In some embodiments of the invention, a plurality of UIEs are embedded in the printed structure; each of the plurality of UIEs is included in its own UIE circuit; and each UIE circuit is encapsulated with a material that won't stick to the other encapsulated UIE circuits. In some embodiments of the invention, a plurality of UIEs are embedded in the printed structure; each of the plurality of UIEs is included in its own UIE circuit; and each UIE circuit is encapsulated with a material that substantially repels the other encapsulated UIE circuits in the liquid state prior to solidification, thus substantially preventing the sticking of the encapsulated UIE circuit to the other encapsulated UIE circuits in the printed structure. In some embodiments of the invention, the encapsulation material provides the previously-described non-stick and/or repellant properties through the application of surface treatments to the encapsulation material. The disclosed methods of encapsulating the UIE circuit ensure that the plurality of UIE circuits will disburse throughout the filaments used to print the physical objects.

In embodiments of the invention, a controller accesses an electronic model of the to-be-printed object, and the electronic model provides instructions that control one or more printheads of a printing device to perform the above-described printing. In some embodiments of the invention, the electronic model can be a 3D model. In general, a 3D model is a mathematical representation of a 3D physical object. 3D models are used to portray real-world and conceptual visuals for art, entertainment, simulation, and drafting and are integral to many different industries, including virtual reality, video games, 3D printing, computer-aided design (CAD) and computer-aided manufacturing (CAM) (CAD/CAM), and the like. In aspects of the invention, CAD technology (or software) is configured and arranged to create the electronic model of the to-be-printed physical object in a manner that satisfies the size, shape, functionality, and performance requirements of the to-be-printed physical object while also taking into account the impact, if any, that the UIE circuits embedded in the physical object will have on the to-be-printed physical object. For example, the CAD software can be configured to identify that printing a given physical object from a given filament such the density of the embedded UIE circuits in the physical object is greater than “X” percent will result in the physical object not meeting the structural integrity requirements input to the CAD software for the given physical object.

As previously noted, in embodiments of the invention, the one or more UIE circuits in the printed UIE-infused 3D physical object are operable to respond to a predetermined stimulus by generating and transmitting a unique/random response. In order to perform post-printing authentication operations for the printed UIE-infused 3D physical object, an interrogator or reader (such as, for example, a transceiver) device is used to broadcast a stimulus signal to the UIE circuits of the printed UIE-infused physical object. The UIE circuits each generate and transmit a unique/random response to the broadcast stimulus, and the interrogator/reader is further operable to receive the unique/random response(s) generated and transmitted by the one or more UIE circuits in the UIE-infused physical object. In some embodiments of the invention, the interrogator/reader is operable to perform multiple iterations of the stimulus/response operations then apply known signal processing operations to the multiple unique/random responses to determine a target value of the unique/random response and a suitable range of acceptable values around the target value of the unique/random response for the printed UIE-infused 3D physical object. The interrogator/reader can associate the response detected by the interrogator/reader with other identifying data of the printed UIE-infused 3D physical object (e.g., serial numbers, date/time/location of fabrication, product description, product features, product model number, and the like) and store the same in a repository. In some embodiments of the invention, the repository can be a relational database having features and functionality that facilitate subsequent searching of the relational database.

In embodiments of the invention, after a printed UIE-infused physical object has been interrogated by an interrogator/reader, the printed UIE-infused physical object is, in effect, “registered” in the repository, and the authenticity of the printed UIE-infused physical object can be confirmed using a product authentication process that interrogates the printed UIE-infused 3D physical object with the proper stimulus, receives the response, and searches the repository to confirm that the received response matches one of the unique/random responses registered in the repository. The product authentication process can also be used to determine whether or not a given printed physical object was in fact fabricated by a given manufacturer. For example, if Manufacturer A is presented with a printed physical object that has the same outward appearance and general features of a UIE-infused 3D physical object produced by Manufacturer A, Manufacturer A can perform the product authentication evaluation process to determine whether or not the printed physical object is an unauthorized copy or an authentic product of Manufacturer A. An interrogator/reader can perform the above-described stimulus/response operations on the to-be-authenticated printed physical object. If no response is received at the interrogator/reader, the to-be-authenticated printed physical object is identified as an unauthorized copy not fabricated by Manufacturer A. If a response is received at the interrogator/reader, the interrogator/reader interrogates the repository to see if the received response matches an entry in the repository. If there is a match, the to-be-authenticated printed physical object is authenticated as an authentic product of Manufacturer A. If there is no match, the to-be-authenticated printed physical object is identified an unauthorized copy not fabricated by Manufacturer A.

In some embodiments of the invention, the printer can be a 3D printer or a four-dimensional (4D) printer. In 4D printing the fourth dimension can be a temperature dimension, where the printed physical object has the ability to change based on the temperature to which it is exposed. In some embodiments of the invention, the UIE can be implemented as a physical unclonable function, or PUF. A PUF is a physical object that, for a given input and conditions (challenge or stimulus), provides a physically defined “digital fingerprint” output (response) that serves as a unique identifier. PUFs are often based on unique physical variations occurring naturally during semiconductor manufacturing. Unlike a conventional cryptographic approach, which uses a single stored key, PUFs work by implementing challenge-response authentication. For a given PUF, a specific input, known as a “challenge”, will generate an output response that is unique to the specific PUF and therefore unclonable. When manufactured, the PUF will be fed a series of different challenges and have its responses recorded. Through this exercise, the designers know each PUF's unique response to a given challenge and can use this information to prevent counterfeiting, create and store cryptographic keys, and many other security feats.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

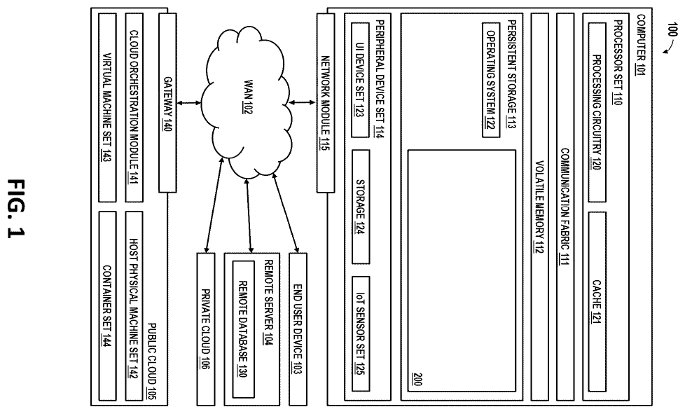

FIG. 1 depicts a computing environment 100 that contains an example of an environment for the execution of at least some of the computer code involved in performing the inventive methods, such as generating UIE-infused 3D models that control the fabrication of UIE-infused 3D physical objects using improved 3D printing control code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

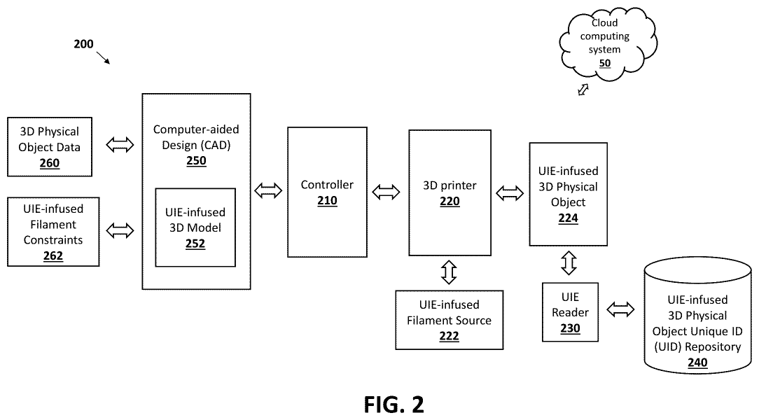

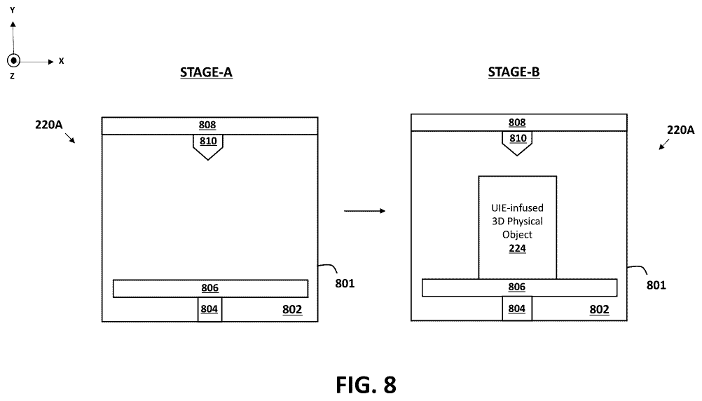

Turning now to a more detailed description of the aspects of the present invention, FIG. 2 depicts a simplified block diagram illustrating a system 200 in accordance with embodiments of the invention. The system 200 includes a controller 210, a 3D printer 220, a UIE-infused filament source 222, a UIE reader (such as, for example, a transceiver) 230, a UIE-infused 3D physical object unique-ID (UID) repository 240, and a CAD module 250, configured and arranged as shown. In some embodiments of the invention, the 3D printer 220 can be a 4D printer. In accordance with aspects of the invention, the controller 210 is operable to load a UIE-infused 3D model 252 from a model file of the CAD module 250. In accordance with embodiments of the invention, the UIE-infused 3D model 252 includes instructions operable to control a printhead 810 (shown in FIG. 8) and the UIE-infused filament source 222 of the 3D printer 220 to form/deposit a corresponding UIE-infused 3D physical object 224.

The CAD module 250 includes and executes CAD software. In general, CAD software is used by different types of engineers and designers to optimize and streamline the designer's workflow, increase productivity, improve the quality and level of detail in the design, improve documentation communications, and often contribute toward a manufacturing design database. CAD software outputs come in the form of electronic files, which are then used accordingly for manufacturing processes. The CAD software in the CAD module 250 can further include computer-aided manufacturing (CAM) software that further assists with planning and executing the fabrication processes.

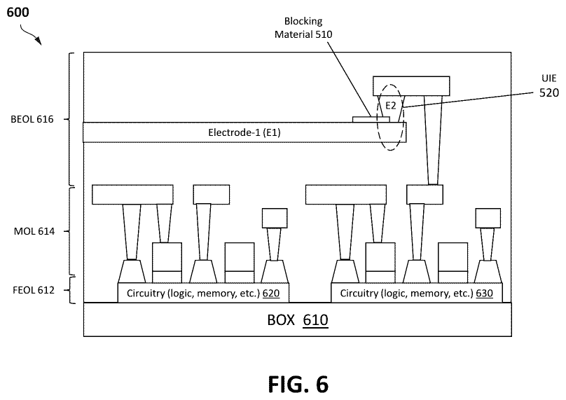

The CAD module 250 includes a full range of CAD software functionality operable to design a UIE-infused 3D electronic model 252 of a to-be-printed UIE-infused 3D physical object 224 based on 3D physical object data 260 and UIE-infused filament constraints 252. In embodiments of the invention, the 3D physical object data 260 and the UIE-infused filament constraints 252 provide the size, dimensions, materials, etc. of the UIE-infused 3D physical object 224 to the CAD module 250. In general, the UIE-infused filament constraints 252 include various details on the size, number, dispersion density, and the like of the UIE circuits 600 (shown in FIG. 6) that will be infused into filaments that will be loaded into the UIE-infused filament source 222 and used by the 3D printer 220 to form the UIE-infused 3D physical object 224. In accordance with aspects of the invention, the UIE-infused 3D model 252 provides instructions to the printhead 810 and the UIE-infused filament source 222, and the printhead 810 uses the instructions to build or print the UIE-infused 3D physical object 224. The printhead 810 builds the UIE-infused 3D physical object 224 by depositing material onto a substrate known as a print bed or a print base (e.g., base 806 shown in FIG. 8). The printhead 810 can be configured to include a nozzle connected to the UIE-infused filament source 222. The UIE-infused filament material provided to the printhead 810 by the UIE-infused filament source 222 is extruded out the nozzle and onto a print base (e.g., base 806 shown in FIG. 8). The printhead 810 is governed by rules or instructions included in its corresponding UIE-infused 3D model 252. The printhead 810 uses the information contained in its corresponding UIE-infused 3D model 252 to determine how much material needs to be deposited and where, exactly, the material should be deposited.

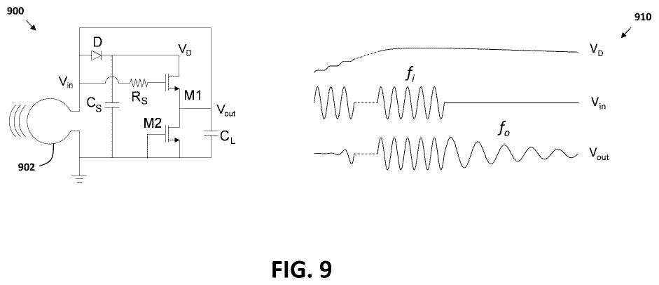

In embodiments of the invention, the UIE-infused 3D physical object 224 includes one or more UIE circuits 600, 600A (shown in FIGS. 6 and 9) that will respond to a predetermined stimulus by generating and transmitting a unique/random response (e.g., Vₒᵤₜ shown in FIG. 9). In embodiments of the invention, the unique/random response operates as a UID of the UIE-infused 3D physical object 224. In some embodiments of the invention, one UIE circuit is provided in each printed UIE-infused 3D physical object 224. In some embodiments of the invention, a plurality of UIE circuits is provided in each printed UIE-infused 3D physical object 224, and the randomness of the collective unique responses generated by the plurality of UIE circuits increases with the total number of UIE circuits provided. In order to perform post-printing authentication operations for the printed UIE-infused 3D physical object 224, the UIE reader 230 is used to broadcast a stimulus signal to the UIE circuits of the printed UIE-infused physical object 224. The UIE reader 230 is further operable to receive the collective unique/random UID response generated by the one or more UIE circuits in the UIE-infused physical object 224. In some embodiments of the invention, the UIE reader 230 is operable to perform multiple iterations of the stimulus/response operations then apply known signal processing operations to the multiple unique/random UID responses to determine a true value of the unique/random UID response and a suitable range of acceptable values around the true value of the unique/random UID response for the printed UIE-infused 3D physical object. The UIE reader 230 can associate the response detected by the UIE reader 230 with other identifying data of the printed UIE-infused 3D physical object (e.g., serial numbers, date/time/location of fabrication, product description, product features, product model number, and the like) and store the same in a repository. In some embodiments of the invention, the repository can be a relational database that facilitate subsequent searching of the relational database.

Although the controller 210, the 3D printer 220, the UIE-infused filament source, the UIE reader 230, and the UIE-infused 3D physical object UID repository 240 are depicted as separate components, it is understood that the depicted components can be integrated with one another in any suitable combination. For example, the controller 210 can be incorporated within the 3D printer 220; the UIE-infused filament source 222 can be incorporated within the 3D printer 220; and/or UIE reader 230 can be incorporated within the UIE-infused 3D physical object UID repository 240.

A cloud computing system 50 is in wired or wireless electronic communication with the system 200. The cloud computing system 50 can supplement, support or replace some or all of the functionality of the various components of the system 200. Additionally, some or all of the functionality of the system 200 can be implemented as a node of the cloud computing system 50. Additional details of cloud computing features of embodiments of the invention are depicted by the computing environment 100 shown in FIG. 1 and described in greater detail previously herein.

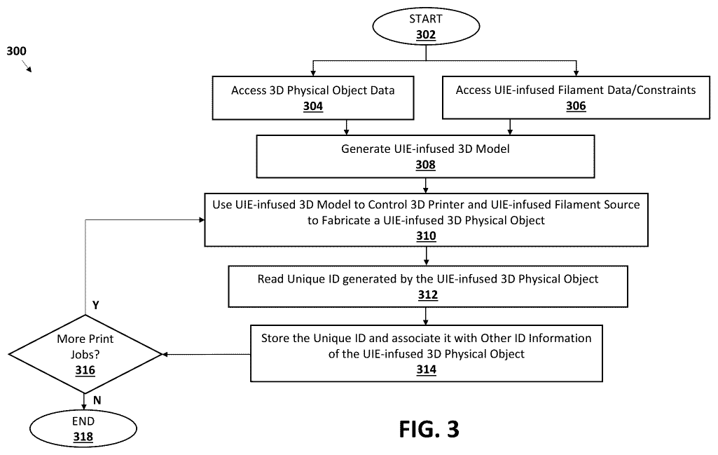

FIG. 3 depicts a flow diagram illustrating a computer-implemented or computer-controlled methodology 300 operable to be performed by the system 200 (shown in FIG. 3) in accordance with embodiments of the invention. The following description of the methodology 300 will refer to both the operations of the methodology 300 and the corresponding component of the system 200 that performs the operations. The methodology 300 begins at block 302 then moves in parallel to blocks 304 and 306. At block 304, the CAD module 250 of the system 200 accesses or receives the 3D physical object data 260, and at block 306, the CAD module 250 also accesses or receives the UIE-infused filament constraints associated with the 3D physical object data 260. The methodology 300 passes the information/data accessed blocks 304 and 306 to block 308, and at block 308 the CAD module 250 uses the information/data generated at blocks 304 and 306 to generate the UIE-infused 3D model 252. At block 310, the controller 210 uses the UIE-infused 3D model 252 to control the 3D printer 220 and the UIE-infused filament source 222 to fabricate or print the UIE-infused 3D physical object 224.

Because the UIE-infused 3D physical object 224 was printed at block 310 using UIE-infused filaments from the UIE-infused filament source 222, the UIE-infused 3D physical object 224 includes one or more UIEs incorporated within UIE circuits in accordance with aspects of the invention. After the UIE-infused 3D physical object 224 has been fabricated at block 310, the methodology 300 moves to block 312 where the UIE reader (or interrogator) 230 is used to read a unique/random UID response transmitted by the UIE circuits of the UIE-infused 3D physical object 224. In embodiments of the invention, the one or more UIE circuits in the printed UIE-infused 3D physical object 224 are operable to respond to a predetermined stimulus by generating and transmitting a unique/random UID response. In order to perform post-printing authentication operations for the printed UIE-infused 3D physical object 224, the interrogator or reader device 230 is used to broadcast a stimulus signal to the UIE circuits of the printed UIE-infused physical object 224. The UIE circuits each generate and transmit a unique/random UID response to the broadcast stimulus, and the UIE reader 230 is further operable to receive the unique/random UID response(s) generated and transmitted by the one or more UIE circuits in the UIE-infused physical object 224. In some embodiments of the invention, the UIE reader 230 is operable to perform multiple iterations of the stimulus/response operations then apply known signal processing operations to the multiple unique/random UID responses to determine a target value of the unique/random UID response and a suitable range of acceptable values around the target value of the unique/random UID response for the printed UIE-infused 3D physical object 224.

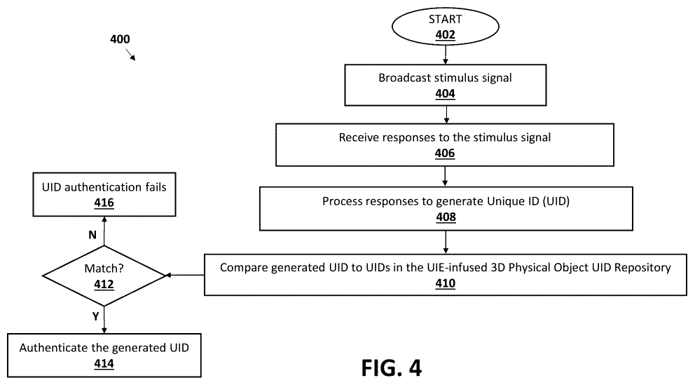

At block 314, the UID is stored and associated with other identifying data/information of the printed UIE-infused 224 that generated and transmitted the UID. In some embodiments of the invention, the UID can be associated with the other identifying data/information of the printed UIE-infused 224 (e.g., serial numbers, date/time/location of fabrication, product description, product features, product model number, and the like) using the UIE reader 230. In some embodiments of the invention, the UIE reader 230 can transmit the UID to the UIE-infused 3D physical object UID repository 240, and the UIE-infused 3D physical object UID repository 240 can associate the response detected by the UIE reader 230 with other identifying data of the printed UIE-infused 3D physical object 224 and store the same in the UIE-infused 3D physical object UID repository 240. In some embodiments of the invention, the UIE-infused 3D physical object UID repository 240 can be a relational database configured to store both data (e.g., numbers) and information (e.g., natural language text that conveys information), as well as the relationships between and among the stored data/information. A suitable relational database that can be used in connection with embodiments of the invention is any relational database configured to provide a means of storing related information in such a way that information and the relationships between information can be retrieved from it. Data in a relational database can be related according to common keys or concepts, and the ability to retrieve related data from a table is the basis for the term relational database. A suitable relational database for implementing the UIE-infused 3D physical object UID repository 240 can be configured to include a relational database management system (RDBMS) that performs the tasks of determining the way data and other information are stored, maintained and retrieved from the relational database. In embodiments of the invention, after the operations at block 314, the printed UIE-infused 3D physical object 224 is, in effect, “registered” in the repository 240, and the authenticity of the printed UIE-infused 3D physical object 224 can be confirmed using a product authentication process (e.g., the methodology 400 shown in FIG. 4).

Subsequent to the operations at block 314, the methodology 300 moves to decision block 316 to determine whether or not additional print jobs for the same UIE-infused 3D model 252 are in the queue for the system 200. If the answer to the inquiry at decision block 316 is yes, the methodology 300 returns to block 310 and performs another iteration of the operations at blocks 310-316. If the answer to the inquiry at decision block 316 is no, the methodology 300 moves to block 318 and ends.

FIG. 4 depicts a flow diagram illustrating a computer-implemented or computer-controlled methodology 400 for performing a product authentication process in accordance with embodiments of the invention. More specifically, the authenticity of the printed UIE-infused 3D physical object 224 can be confirmed using the methodology 400. The methodology 400 begins at block 402 then moves to block 404 where the UIE reader 230 interrogates the printed UIE-infused 3D physical object 224 with the proper stimulus. At block 406, the UIE reader 230 receives a response, if any, to the stimulus. If no response to the stimulus is received, the response is assumed to be a null set or zero (0). At block 408, the UIE reader 230 processes the response to generate a UID. At block 410, the UIE reader 230 provides the UID to the UIE-infused 3D physical object UID repository 240 as a search query. The repository 240 searches its entries and compares the received UID to the UID responses registered in the repository 240. From block 410, the methodology 400 moves to decision block 412 to determine whether or not the search/comparisons performed at block 410 resulted in a match. If the answer to the inquiry at decision block 412 is yes, the methodology 400 moves to block 414 and authenticates the UID. If the answer to the inquiry at decision block 412 is no, the methodology 400 moves to block 416 and determines that the authentication of the UID failed.

The product authentication process represented by the methodology 400 can also be used to determine whether or not a given printed physical object was in fact fabricated by a give manufacturer. For example, if Manufacturer A is presented with a printed physical object that has the same outward appearance and general features of a UIE-infused 3D physical object produced by Manufacturer A, Manufacturer A can perform the methodology 400 as a product authentication evaluation process to determine whether or not the printed physical object is an unauthorized copy or an authentic product of Manufacturer A. A UIE reader 230 can perform the above-described stimulus/response operations (blocks 404, 406, 408) on the to-be-authenticated printed physical object. If no response is received at the UIE reader 230, the to-be-authenticated printed physical object is identified as an unauthorized copy not fabricated by Manufacturer A. If a response is received at the UIE reader 230, the UIE reader 230 interrogates the repository 240 (block 410) to determine whether or not the received response matches an entry in the repository 240 (decision block 412). If there is a match, the to-be-authenticated printed physical object is authenticated as an authentic product of Manufacturer A (block 414). If there is no match, the to-be-authenticated printed physical object is identified an unauthorized copy not fabricated by Manufacturer A (block 416).

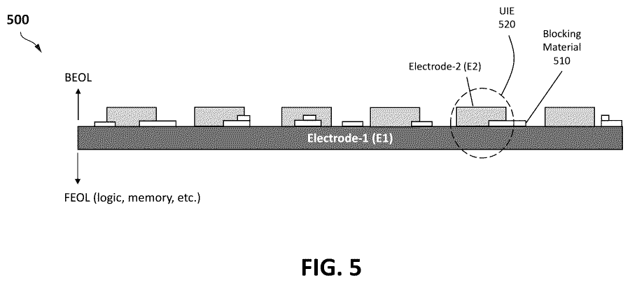

FIG. 5 depicts a non-limiting example of a semiconductor structure 500 that includes a plurality of UIEs 520 that can be used to implement a UIE integrated circuit (IC) 600 (shown in FIG. 6) in accordance with embodiments of the invention. The structure 500 includes a first electrode identified as E1; a set of second electrodes identified as E2; and a blocking material 510, configured and arranged as shown. Known semiconductor fabrication operations are used to form E1, and the blocking material 510 is nucleated on E1 in a random pattern. E2 is patterned and formed (e.g., with a periodic structure). The electrodes E1, E2 can be any suitable conductive materials such as metal and highly doped semiconductor. The blocking material 510 can be an insulating layer or a material that forms a rectifying (non-ohmic) contact with either or both of the two electrodes E1, E2 (e.g., a p-n junction(s), p-i-n junction(s), and/or Schottky junction(s)). In accordance with aspects of the invention, one or more characteristic of the blocking material 510 are manipulated to provide a predetermined level of randomness that is unique and detectable. For example, the blocking material 510 can be a “random component” that is different (e.g., the size, shape, location, and/or fabrication technique of an insulator) for each fabricated instance of the blocking material 510 and is provided at a level that is sufficient to substantially cause the unique characteristic (e.g., a resistance of the UIE 520). As a result of the blocking material (or random component) 520, the effective resistance of the UIE 520 as measured between the two electrodes E1, E2 has an intentionally created and measurable random distribution.

In some embodiments of the invention, the barrier material 510 is deposited on E1 using a nucleation of the blocking material 510 upon a surface of the electrode E1. Deposition does not continue to the point of forming a complete film or coating of the blocking material 510 on the electrode E1. Nucleation refers to the clustering or grouping of molecules of the barrier material 510 upon the surface, typically, but not necessarily, in a single layer of molecules upon the surface. Clusters expand in size as the deposition process continues and a complete film or layer of the barrier material 510 would eventually form on the electrode E1 given sufficient deposition process duration. Suitable deposition processes for forming the nucleations of the blocking material 510 include atomic layer deposition (ALD), flash deposition, epitaxy, and the like. In ALD, various ALD growth parameters and substrate (E1) conditions can be adjusted to control the nucleation. In flash deposition, typically after reaching stable conditions, a shutter is opened for a very short period and closed. Typically flash deposition rates up to few A/s and shutter open times of up to few seconds are used. The flash deposition process can include, e.g., thermal/e-beam evaporation, CVD (e.g. PECVD), and the like. In epitaxial growth, e.g., vapor phase or molecular beam epitaxy, various growth parameters as well as substrate conditions can be adjusted to control the nucleation and initial growth.

FIG. 6 depicts a non-limiting example of the UIE IC 600 in accordance with embodiments of the invention. The UIE IC 600 includes a buried oxide (BOX) layer 610 formed over a substrate (not shown); a front-end-of-line (FEOL) region 612 formed over the BOX layer 610; a middle-of-line region 614 formed over the FEOL region 612; and a back-end-of-line (BEOL) region 616 formed over the MOL region 614, configured and arranged as shown. The UIE IC 600 is fabricated in a series of stages, including a FEOL stage, a MOL stage, and a BEOL stage. In the FEOL stage, the FEOL region 612 is formed. In the FEOL region 612, device elements (e.g., circuitry 620, 630) transistors) are patterned and fabricated using known semiconductor fabrication operations. The MOL stage forms the MOL region 614, which includes a variety of interconnect structures (e.g., lines, wires, metal-filled vias, contacts, and the like) that communicatively couple to active regions (e.g., gate, source, and drain) of the device element (e.g., circuitry 620, 630). Layers of interconnect structures (e.g., E1, E2, and UIE 520) are formed above these logical and functional layers during the BEOL stage to form the BEOL region 616 and complete the UIE IC 600.

The UIE IC 600 is operable to receive a stimulus signal and generate a unique/random response to the stimulus signal. The UIE 520 is located within the UIE IC 600 such that the unique characteristic of the blocking material 510 of the UIE 520 is at a sufficient level to cause the response of the UIE IC 600 to be unique, random and detectable. In embodiments of the invention, the stimulus signal and the unique/random response are transmitted and received wirelessly. Additional details of a circuit diagram illustration of an example the UIE IC 600, the stimulus signal, and the response signal are depicted in FIG. 9 and described in greater detail subsequently herein.

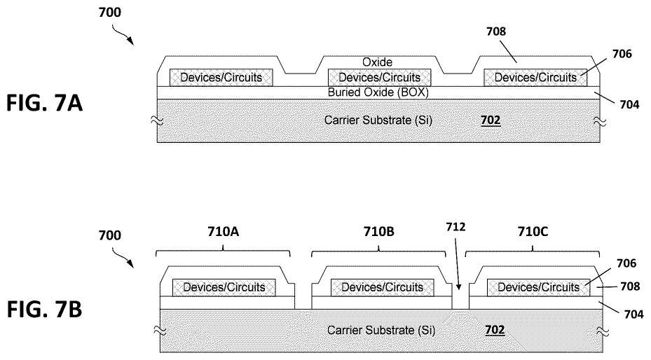

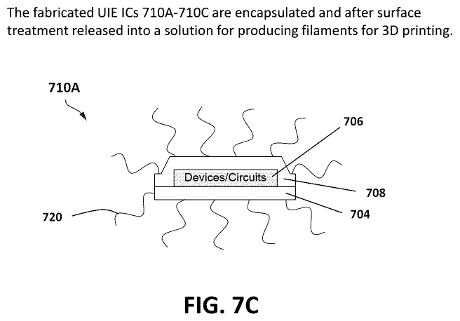

FIGS. 7A-7C depict fabrication steps for forming a plurality of encapsulated UIE ICs 710A, 710B, 710C to be embedded within polymer filament for forming the UIE-infused 3D physical object 224 (shown in FIGS. 1 and 8). Referring now to FIG. 7A, known semiconductor fabrication operations have been used to form a semiconductor structure 700 having a carrier substrate 702 and a BOX layer 704. The carrier substrate 702 can include a silicon-based material. Illustrative examples of silicon-based materials suitable for the carrier substrate 702 can include, but are not limited to, silicon, silicon, silicon-germanium, silicon-germanium-carbon, silicon-carbon, and multi-layers thereof. The BOX layer 704 can be formed by ion implantation or wafer bonding. Known semiconductor fabrication operations have also been used to form devices/circuit 706 on the BOX layer 704. The semiconductor devices 706 can include, for example, the UIE circuitry 900 (shown in FIG. 9). The semiconductor devices 706 can include one or more energy harvesting devices, including, for example; solar cells; RF coils; batteries; wireless transmission devices such as antennas; capacitors; and the like.

Known semiconductor fabrication operations have also been used to form an oxide layer 708 on the devices/circuits 706 and exposed portions of the BOX layer 704. The oxide layer 708 can be a non-crystalline solid material such as silicon dioxide, undoped silicate glass, fluorosilicate glass, borophosphosilicate glass, a spin-on low-k dielectric layer, a chemical vapor deposition low-k dielectric layer or any combination thereof. The term “low-k” as used throughout the present disclosure denotes a dielectric material that has a dielectric constant of less than silicon dioxide. In another embodiment, a self-planarizing material such as a spin-on glass (SoG) or a spin-on low-k dielectric material can be used as the oxide layer 708. The use of a self-planarizing dielectric material as the oxide layer 708 can avoid the need to perform a subsequent planarizing step. In some embodiments of the invention, the oxide layer 708 can be formed on utilizing a deposition process including, for example, chemical vapor deposition, plasma enhanced chemical vapor deposition, evaporation, or spin-on coating. In some embodiments of the invention, particularly when non-self-planarizing dielectric materials are used as the oxide layer 708, a planarization process or an etch back process follows the deposition of the material that provides the oxide layer 708. Thus, the devices/circuits 706 can be capped with the oxide layer 708. Pre-programming of certain devices/circuits 706, such as memory devices, can be performed before the capping if required. Metal wiring passing between the units that can be used for device programming or testing can be etched away by conventional lithography prior to capping.

Referring now to FIG. 7B, known semiconductor fabrication operations have been used to form one or more trenches 712 in the oxide layer 708 of the semiconductor structure 700. The etch process can include reactive ion etching, laser ablation, or any etch process which can be used to selectively remove a portion of material. The etch process is performed through the oxide layer 708 and the BOX layer 704 down to the carrier substrate 702.

Referring now to FIG. 7C, known semiconductor operations have been used to separate the individual encapsulated UIE ICs 710A, 710B, 710C from the carrier substrate 702. In some embodiments of the invention, the process for separating the individual encapsulated UIE ICs 710A, 710B, 710C from the carrier substrate 702 can include forming a handle layer (not shown) on the semiconductor structure 700 shown in FIG. 7B. The handle layer is deposited on top of the oxide layer 708. In some embodiments of the invention, the handle layer includes a spin-on water-soluble material such as polyvinyl alcohol. In some embodiments of the invention, the handle layer includes a spin-on resist, which is soluble in organic solvents. In some embodiments of the invention, the handle layer includes a cleave layer (e.g., sputtered amorphous zinc-oxide), a stressor layer (e.g., sputtered nickel), and a flexible support substrate attached thereon using an adhesive, which is subsequently used to remove the flexible support substrate by cleaving through the cleave layer. The handle layer can be deposited utilizing deposition techniques including, for example, dip coating, spin-coating, brush coating, sputtering, chemical vapor deposition, plasma enhanced chemical vapor deposition, chemical solution deposition, physical vapor deposition, and plating. In some embodiments of the invention, the handle layer can be applied atop the oxide layer 708 by hand or by mechanical means. The carrier substrate 702 can be removed by mechanical grinding, chemical wet and/or dry etching, or any combination thereof. The carrier substrate 702 can also be removed by controlled spalling through the carrier substrate 702 close to the BOX layer 704, followed by chemical etching. Subsequent to removing the carrier substrate 702, the handle layer can be dissolved or detached in a wet solution.

As shown in FIG. 7C, the UIE ICs 710A, 710B, 710C (for ease of illustration only UIE IC 710A is shown in FIG. 7C) can be released into a precursor solution for forming filaments, and then functionalized. The UIE ICs 710A, 710B, 710C can be dispersed in a polymer carrier in an either aqueous solution or organic solvent. For organic solvent dispersion, the UIE ICs 710A, 710B, 710C can be first coated with monolayers of alkylsilanes by immersing the UIE ICs 710A, 710B, 710C in a dilute (e.g. 0.1-1%) solution of alkyl trimethoxysilane and then rinsing with the solvent (e.g., ethanol, or water or the mixture of). In this process, the surface of the UIE ICs 710A, 710B, 710C can be coated with monolayers of long chain (2-16 carbon atoms) alkyl group which can allow for dispersal in a carrier and prevent agglomeration of the UIE ICs 710A, 710B, 710C. Coated UIE ICs 710A, 710B, 710C can be added to a solution of a polymer such as, e. g., nitrocellulose (2-10% by solid) in ethyl or butyl acetate and stirred or sonicated to form uniform dispersion. The resulting non-stick and/or self-repellant characteristics of the UIE ICs 710A, 710B, 710C are depicted by the reference number 720 shown in FIG. 7C.

For aqueous dispersion of the UIE ICs 710A, 710B, 710C, UIE ICs 710A, 710B, 710C can be first coated, for example, with polyetheneoxide end-caped with trialkoxysilane to form a hydrophilic monolayer on the UIE ICs 710A, 710B, 710C. The coated UIE ICs 710A, 710B, 710C are then dispersed in an aqueous solution, for example, of a mixture of polyvinylpyrrolidone and polyethyleneoxide diacrylate.

The above operations can be incorporated in a solution blending process so that the UIE ICs 710A, 710B, 710C are dispersed in a polymer blend. Polymer blends are widely used for 3D and 4D printing. A polymer blend can refer to a blended mixture of two or more polymers. A polymer blend can also refer to a blended mixture of one or more polymers with other materials such as ceramics, carbon nanostructures or other fillers. The polymers can include, among other things, polylactic acid (PLA), acrylonitrile butadiene (ABS), polyethylene terephthalate glycol (PETG), polypropylene (PP), carbon fiber, nylon, high-impact polystyrene (HIPS), thermoplastic elastomers, or any other suitable polymer.

Polymer powder with embedded or infused with the UIE ICs 710A, 710B, 710C can be produced from the solution. For example, the solution can be cooled down from 80-100° C. to room-temperature to induce precipitation of polymer particles formed from polymer grains with embedded UIE ICs 710A, 710B, 710C, separating the precipitate, drying and mechanical treatment (milling, grinding, chipping, etc.).

The plastic (i.e., polymer) powder with embedded UIE ICs 710A, 710B, 710C can be used to produce plastic pellets with the UIE ICs 710A, 710B, 710C. Each plastic grain in the powder or a plastic pellet can contain one or more (e.g., thousands or more) UIE ICs 710A, 710B, 710C, which can be incorporated into the filament and then the UIE-infused 3D physical object 224. The plastic pellets with embedded UIE ICs 710A, 710B, 710C can be used to produce the UIE-infused filaments loaded into the UIE-infused filament source 222. Filaments can also be produced directly from powder. It can be appreciated that substantially any technique, such as melt-blending, used for producing filaments from powders or pellets can be used. The filaments infused with the UIE ICs 710A, 710B, 710C can be used for printing the UIE-infused 3D physical object 224.

FIG. 8 depicts additional details of how the printer 220A (shown in FIG. 1) can be implemented as a printer 220A, and further illustrates a STAGE-A in which printing has not yet started, as well as a STAGE-B in which printing of the UIE-infused 3D physical objects 224 has completed. At STAGE-A, the controller 210 has accessed the UIE-infused 3D model 252. FIG. 2 depicts a cross-sectional view of a portion of the printer 220A in accordance with embodiments of the present invention. The printer 220A includes a main body 801 having an interior 802. The interior 802 houses a printhead assembly formed from a printhead support 808 interconnected to a printhead 810. The printhead assembly 808/810 is positioned above a print base 806 that is interconnected to base support 804.

The printer 220A represents an automated manufacturing apparatus. In an embodiment of the present invention, the printer 220A can be, for example, a 3D printer or a 4D printer. In embodiments of the invention, the printer 220A can implement, for example, an additive manufacturing process such as fused filament fabrication in printing the UIE-infused 3D physical object 224. The UIE-infused 3D physical object 224 can be a part, item, object, or the like. In embodiments of the invention, the printer 220A may implement, for example, a spatial orientation and positioning system that can include control systems, actuators, sensors, hardware, and the like, to spatially orient and position the print assemblies 810/808 by way of the print base 806. Spatial orientation and positioning of the print base 806 or the printhead assemblies 808/810, or both, can occur along or about one or more of the X-, Y-, and Z-axes of a three-dimensional Cartesian coordinate system defined with respect to the printer 220A. A closed loop control system can be implemented by the printer 220A to actuate motors, such as DC stepper motors, to respectively orient and position the print bases 806 or the printhead assemblies 808/810, or both, according to control data generated by encoders associated with the DC stepper motors under control of the UIE-infused 3D model 252. The printer 220A can include automated stereoscopic computer vision to monitor each printed layer during printing to ensure that an item such as the UIE-infused 3D physical object 224 prints correctly. Other spatial orientation and positioning systems can be used as a matter of design choice based on a particular application at-hand.

The printhead support 808 represents part of the spatial orientation and positioning system of the printer 220A used to support and spatially orient and position the printhead 810 in printing the UIE-infused 3D physical object 224. In embodiments of the invention, the printhead support 808 can include, for example, a mount, carriage, chuck, or the like, to support and spatially orient and position one or more instances of the printhead 810 within the interior 802 of the printer 220A. In embodiments of the invention, the printhead support 808 can, for example, support its corresponding printhead 810 for spatial orientation and positioning within interior 802 along or about one or more of the X-, Y-, and Z-axes of the printer 220A. In embodiments of the invention, the printhead support 808 can include, for example, a translational stage such as a one-, two-, three-, four-, five-, or six-axis stage, or the like. For example, the printhead support 808 can be formed of two one-axis stages, connected to effect two-axis stage functionality in operation, and so on. In embodiments of the invention, the printhead support 808 can further include, for example, a linear bearing, rail, track, brace, guide rod, or the like. For example, the printhead support 808 can include a mount for receiving and supporting the printhead 810, the mount being attached to one or more linear bearings, to effect spatial orientation and positioning of the printhead 810 within the interior 802 during operation of the printer 220A.

The printhead 810 represents an extruder of the printer 220A used in printing the UIE-infused 3D physical object 224. In embodiments of the invention, the printhead 810 can be, for example, an extruder or the like. In embodiments of the invention, the printhead 810 can implement, for example, an additive manufacturing process such as fused filament fabrication in printing the 3D physical object. During operation, the printhead 810 receives or draws material, in the form of plastic or metallic filament, from a supply (e.g., the UIE-infused filament source 222) for heating, melting, and extruding of the drawn material from nozzles of the printhead 810. The extruded material is formed and deposited in layers on or along a corresponding surface of a corresponding print bases 806 to form the printed UIE-infused 3D physical object 224. In embodiments of the invention, the extruded material can include, for example, plastic material such as acrylonitrile butadiene styrene (ABS), polylactic acid (PLA), high-impact polystyrene (HIPS), thermoplastic polyurethane (TPU), aliphatic polyamides (nylon), polypropylene (PP), polyetherimide (PEI), polyether ether ketone (PEEK), acrylonitrile styrene acrylate (ASA), polycarbonate (PC), polyethylene terephthalate (PET), polyoxymethylene (POM), polyvinyl alcohol (PVA), or the like. In embodiments of the invention, the extruded material may otherwise include wood fill material, metallic material, conductive material, or the like.

At STAGE-B, the print base 806 represents a build surface used by the printer 220A to deposit extruded material for support in printing the UIE-infused 3D physical object 224. In embodiments of the present invention, the print base 806 can be or include, for example, a print bed, build plate, platform, table, board, sheet, laminate, or the like. A top surface of the print base 806A receives and supports extruded material deposited by a corresponding printhead 810 in printing the UIE-infused 3D physical object 224. A size or surface area of the print bases 806, such as with respect to the top surface, can be chosen according to a size of an item to be printed, such as the UIE-infused 3D physical object 224.

The base support 804 represents part of the spatial orientation and positioning system of the printer 220A used to support and spatially orient and position the base assemblies 806/806 in printing the UIE-infused 3D physical object 224. In embodiments of the invention, the base support 804 can be, for example, a robotic arm, or the like. In embodiments of the invention, the base support 804 can include, for example, a platform, mount, carriage, chuck, end effector, or the like, to attach to, support and spatially orient and position the base assembly 806 within, or inside, outside, and about the interior 802 of the printer 220A. The robotic arm can include stereoscopic computer vision. In embodiments of the invention, the base support 804 can, for example, support the base assembly 806 for spatial orientation and positioning within, outside, and about the interior 802 along or about one or more of the X-, Y-, and Z-axes of the printer 220A. In embodiments of the invention, upon completion of printing, the base support 804 can move the base assembly for detachment of the UIE-infused 3D physical object 224 from the base assembly 806. In embodiments of the invention, the base support 804 can be, for example, a conveyor belt, or the like.

FIG. 9 depicts details of a circuit diagram illustration of an example of a wireless UIE circuit 900 that can be used to implement one or more of the UIE ICs 600, 710A, 710B, 710C. FIG. 9 also depicts a signal diagram 910 the stimulus signal (Vin) and the response signal (Vout) generated by the UIE circuit 900. The UIE circuit 900 includes a bi-directional antenna 902, a first capacitive element C_{S}, a diode D, a resistance element R_{S}, a first transistor M1, a second transistor M2, and a second capacitive element C_{L}, configured and arranged as shown. The example UIE circuit 900, in response to a stimuli with frequency fᵢ, backscatters a response with frequency fₒ which is a function of the resistor value Rₛ. The UIE reader 230 (shown in FIG. 1) can send the stimuli (input frequency) fᵢ and receive the backscattered frequency fₒ. As an example, if 100 instance of the UIE circuit 900 (each with a random resistor Rₛ) are embedded in the UIE-infused 3D physical object 224, the backscattered frequency will have peaks at 100 random frequencies. This generates a unique and unclonable response for the UIE-infused 3D physical object 224, because each UIE-infused 3D physical object 224 will have 100 random unique frequency peaks.

In embodiments of the invention, the number of UIE circuits 900 embedded in each UIE-infused 3D physical object 224 can also include randomness. For example, if the UIE-infused filament is pulled from a dispersed solution with some degree of inhomogeneity, the number of UIE circuits 900 per UIE-infused 3D physical object 224 can vary from the mean value of one-hundred (100) with a standard deviation of, for example, ten (10). Therefore, the number of random frequency peaks in the response will vary accordingly.

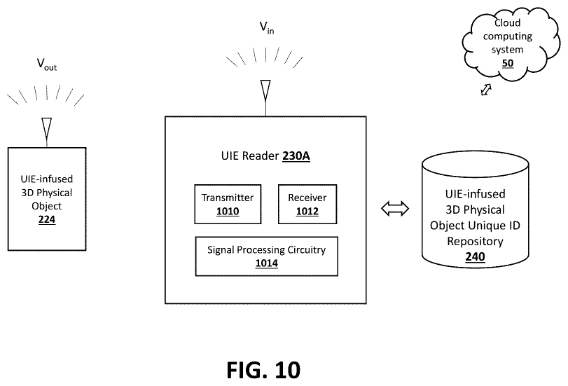

FIG. 10 depicts additional details of how the UIE reader 230 (shown in FIG. 1) can be implemented as UIE reader 230A and used to perform the methodology 400 (shown in FIG. 4) in accordance with aspects of the invention. The UIE reader 230A includes a transmitter 1010, a receiver 1012, and signal processing circuitry 1014, configured and arranged as shown. Referring now to FIG. 4, FIG. 9, and FIG. 10, the authenticity of the printed UIE-infused 3D physical object 224 can be confirmed using the methodology 400. The methodology 400 begins at block 402 then moves to block 404 where the UIE reader 230A interrogates the printed UIE-infused 3D physical object 224 by broadcasting through the signal processing circuitry 1014 and the transmitter 101 with the proper stimulus (e.g., Vᵢₙ). At block 406, the UIE reader 230 receives a response, if any, to the stimulus. If no response to the stimulus is received, the response is assumed to be a null set or zero (0). At block 408, the UIE reader 230A processes the response using the signal processing circuitry 1014 to generate a UID. At block 410, the UIE reader 230A provides the UID to the UIE-infused 3D physical object UID repository 240 as a search query. The repository 240 searches its entries and compares the received UID to the UID responses registered in the repository 240. From block 410, the methodology 400 moves to decision block 412 to determine whether or not the search/comparisons performed at block 410 resulted in a match. If the answer to the inquiry at decision block 412 is yes, the methodology 400 moves to block 414 and authenticates the UID. If the answer to the inquiry at decision block 412 is no, the methodology 400 moves to block 416 and determines that the authentication of the UID failed.

The product authentication process represented by the methodology 400 can also be used to determine whether or not a given printed physical object was in fact fabricated by a give manufacturer. For example, if Manufacturer A is presented with a printed physical object that has the same outward appearance and general features of a UIE-infused 3D physical object produced by Manufacturer A, Manufacturer A can perform the methodology 400 as a product authentication evaluation process to determine whether or not the printed physical object is an unauthorized copy or an authentic product of Manufacturer A. The UIE reader 230A can perform the above-described stimulus/response operations (blocks 404, 406, 408) on the to-be-authenticated printed physical object. If no response is received at the UIE reader 230A, the to-be-authenticated printed physical object is identified as an unauthorized copy not fabricated by Manufacturer A. If a response is received at the UIE reader 230A, the UIE reader 230A interrogates the repository 240 (block 410) to determine whether or not the received response matches an entry in the repository 240 (decision block 412). If there is a match, the to-be-authenticated printed physical object is authenticated as an authentic product of Manufacturer A (block 414). If there is no match, the to-be-authenticated printed physical object is identified an unauthorized copy not fabricated by Manufacturer A (block 416).

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

“Planarization” and “planarize” as used herein refer to a material removal process that employs at least mechanical forces, such as frictional media, to produce a substantially two-dimensional surface. A planarization process can include chemical mechanical polishing (CMP) or grinding. CMP is a material removal process that uses both chemical reactions and mechanical forces to remove material and planarize a surface.

The phrase “selective to,” such as, for example, “a first element selective to a second element,” means that the first element can be etched and the second element can act as an etch stop.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The term “conformal” (e.g., a conformal layer) means that the thickness of the layer is substantially the same on all surfaces, or that the thickness variation is less than 15% of the nominal thickness of the layer.

The terms “epitaxial growth and/or deposition” and “epitaxially formed and/or grown” mean the growth of a semiconductor material (crystalline material) on a deposition surface of another semiconductor material (crystalline material), in which the semiconductor material being grown (crystalline overlayer) has substantially the same crystalline characteristics as the semiconductor material of the deposition surface (seed material).

As previously noted herein, for the sake of brevity, conventional techniques related to semiconductor device and IC fabrication may or may not be described in detail herein. By way of background, however, a more general description of the semiconductor device fabrication processes that can be utilized in implementing one or more embodiments of the present invention will now be provided. Although specific fabrication operations used in implementing one or more embodiments of the present invention can be individually known, the described combination of operations and/or resulting structures of the present invention are unique. Thus, the unique combination of the operations described in connection with the fabrication of a semiconductor device according to the present invention utilize a variety of individually known physical and chemical processes performed on a semiconductor (e.g., silicon) substrate, some of which are described in the immediately following paragraphs.

In general, the various processes used to form a micro-chip that will be packaged into an IC fall into four general categories, namely, film deposition, removal/etching, semiconductor doping and patterning/lithography. Deposition is any process that grows, coats, or otherwise transfers a material onto the wafer. Available technologies include physical vapor deposition (PVD), chemical vapor deposition (CVD), electrochemical deposition (ECD), molecular beam epitaxy (MBE) and more recently, atomic layer deposition (ALD) among others. Removal/etching is any process that removes material from the wafer. Examples include etch processes (either wet or dry), chemical-mechanical planarization (CMP), and the like. Reactive ion etching (RIE), for example, is a type of dry etching that uses chemically reactive plasma to remove a material, such as a masked pattern of semiconductor material, by exposing the material to a bombardment of ions that dislodge portions of the material from the exposed surface. The plasma is typically generated under low pressure (vacuum) by an electromagnetic field. Semiconductor doping is the modification of electrical properties by doping, for example, transistor sources and drains, generally by diffusion and/or by ion implantation. These doping processes are followed by furnace annealing or by rapid thermal annealing (RTA). Annealing serves to activate the implanted dopants. Films of both conductors (e.g., poly-silicon, aluminum, copper, etc.) and insulators (e.g., various forms of silicon dioxide, silicon nitride, etc.) are used to connect and isolate transistors and their components. Selective doping of various regions of the semiconductor substrate allows the conductivity of the substrate to be changed with the application of voltage. By creating structures of these various components, millions of transistors can be built and wired together to form the complex circuitry of a modem microelectronic device. Semiconductor lithography is the formation of three-dimensional relief images or patterns on the semiconductor substrate for subsequent transfer of the pattern to the substrate. In semiconductor lithography, the patterns are formed by a light sensitive polymer called a photo-resist. To build the complex structures that make up a transistor and the many wires that connect the millions of transistors of a circuit, lithography and etch pattern transfer steps are repeated multiple times. Each pattern being printed on the wafer is aligned to the previously formed patterns and slowly the conductors, insulators and selectively doped regions are built up to form the final device.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The descriptions of the various embodiments of the present invention have been presented for purposes of illustration but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer system comprising a memory coupled to a processor system, wherein the processor system is operable to perform processor system operations comprising:
accessing a model of a physical object;
accessing instructions associated with the model of the physical object; and
using the instructions to control a printhead coupled to a unique-identifier-element-infused (UIE-infused) filament source to print the physical object from UIE-infused filament.

2. The computer system of claim 1, wherein the UIE-infused filament comprises a plurality of UIEs.

3. The computer system of claim 2 wherein the plurality of UIEs are dispersed from one another.

4. The computer system of claim 3, wherein:
a first one of the plurality of UIEs is encapsulated by a first encapsulate material;
a second one of the plurality of UIEs is encapsulated by a second encapsulate material; and
the first encapsulate material is operable to repel the second encapsulate material.

5. The computer system of claim 2, wherein a first one of the plurality of UIEs comprises a wireless UIE circuit operable to, in response to a stimulus from a reader device, generate and transmit a unique response.

6. The computer system of claim 5, wherein the unique response is received and read by the reader device.

7. The computer system of claim 6, wherein the unique response is utilized in a process operable to determine that the physical object is not an unauthorized copy.

8. A computer-implemented method comprising:
accessing, using a processor system, a model of a physical object;
accessing, using the processor system, instructions associated with the model of the physical object; and
using the instructions to control a printhead coupled to a unique-identifier-element-infused (UIE-infused) filament source to print the physical object from UIE-infused filament.

9. The computer-implemented method of claim 8, wherein the UIE-infused filament comprises a plurality of UIEs.

10. The computer-implemented method of claim 9 wherein the plurality of UIEs are dispersed from one another.

11. The computer-implemented method of claim 10, wherein:
a first one of the plurality of UIEs is encapsulated by a first encapsulate material;
a second one of the plurality of UIEs is encapsulated by a second encapsulate material; and
the first encapsulate material is operable to repel the second encapsulate material.

12. The computer-implemented method of claim 8, wherein a first one of the plurality of UIEs comprises a wireless UIE circuit operable to, in response to a stimulus from a reader device, generate and transmit a unique response.

13. The computer-implemented method of claim 12, wherein the unique response is received and read by the reader device.

14. The computer-implemented method of claim 13, wherein the unique response is utilized in a process operable to determine that the physical object is not an unauthorized copy.

15. A computer program product comprising a computer readable program stored on a computer readable storage medium, wherein the computer readable program, when executed on a processor system, causes the processor system to perform processor system operations comprising:
accessing a model of a physical object;
accessing instructions associated with the model of the physical object; and
using the instructions to control a printhead coupled to a unique-identifier-element-infused (UIE-infused) filament source to print the physical object from UIE-infused filament.

16. The computer program product of claim 15, wherein the UIE-infused filament comprises a plurality of UIEs.

17. The computer program product of claim 16 wherein the plurality of UIEs are dispersed from one another.

18. The computer program product of claim 17, wherein:
a first one of the plurality of UIEs is encapsulated by a first encapsulate material;
a second one of the plurality of UIEs is encapsulated by a second encapsulate material; and
the first encapsulate material is operable to repel the second encapsulate material.

19. The computer program product of claim 16, wherein a first one of the plurality of UIEs comprises a wireless UIE circuit operable to, in response to a stimulus from a reader device, generate and transmit a unique response.

20. The computer program product of claim 19, wherein the unique response is:
received and read by the reader device; and
utilized in a process operable to determine that the physical object is not an unauthorized copy.
